(19) United States
(12) Patent Application Publication
(10) Pub. No.: US 2009/0078443 A1
(43) Pub. Date: Mar. 26, 2009

(54) Ceiling fan mounting base

(76) Inventor: Alan P. Halbert, Bluffdale, UT (US)

Correspondence Address: Alan P. Halbert, 2956 West 15000 South, Bluffdale, UT, 84065, US

(21) Appl. No.: 12/234,708

(22) Filed: Sep. 21, 2008

Related U.S. Application Data
(60) Provisional application No. 60/994,905, filed on Sep. 22, 2007.

(51) Int. Cl. H02G 3/30

(52) U.S. Cl. 174/63

(57) ABSTRACT

The disclosed inventions relate generally to electrical boxes that may be installed to a ceiling, and more particularly to electrical box ancillary devices, such as brackets, plates and struts, that permit the carrying of heavy ceiling appliances such as ceiling fans and lighting fixtures. Disclosed herein are structural plates and other devices for attachment of ceiling fans and heavy lighting fixtures to structural members, such as trusses and joists, against the load of these fixtures. Also disclosed herein, explicitly or implicitly are methods of using and installing these plates and or brackets, devices and boxes. Detailed information on various example embodiments of the inventions is provided in the Detailed Description below.

### CROSS-REFERENCE TO RELATED APPLICATIONS

This application claims the benefit of provisional U.S. Application No. 60/994,905 filed Sep. 22, 2007, which is hereby incorporated by reference in its entirety.

### BACKGROUND OF THE INVENTIONS

Known in the art are electrical boxes intended to enclose wiring and connectors, those boxes also include mountings for securing a lighting fixture. Certain of those boxes are suitable for mounting overhead just above a ceiling, attaching to a truss, joist or other structural support member. In a typical new installation, metal or more frequently plastic light-duty boxes are installed, those being the most inexpensive type suitable for carrying a light-weight lighting fixture, for example a fixture housing a single medium-base bulb. It is often the case that a homeowner will wish to later install a heavier fixture, such as a ceiling fan or chandelier, to the originally installed electrical box. Many homeowners are not aware of the unsuitability of these light-weight boxes for those applications, and many install these heavier fixtures improperly and dangerously without upgrading the supporting structure.

A Ceiling fan creates stress on the electrical box it is attached to due to torque. If attached to a light-duty box, these forces may carry through the fan support to the electrical box, which may cause the box to twist slightly on each rotation of the fan. Over time this motion may cause the nails, or other fasteners used to secure the electrical box to move and/or loosen, which may lead to failure of the electrical box supporting structure. Additionally, if the box structure is not sufficiently rigid, forces may be transferred to the drywall, or other material of the ceiling. Now drywall, plaster, paneling and most other ceiling materials are not designed to carry dynamic loads. These materials may carry a dynamic load briefly, but over time this may lead to an unpredictable failure of the material. If both the electrical box supporting structure and the ceiling material fail, the result is a fixture falling at an unpredictable time. This can lead to property damage, personal injury and litigation against the makers of the ceiling fan, lighting fixture, electrical box manufacturer as well as other involved parties.

In many areas earthquakes are a concern. A non-moving ceiling fixture mounted to a light-weight box may carry a load sufficiently well under static conditions for many years. Earthquakes are unpredictable events that may occur at any time and in some locations with such severity as to cause large thrust and oscillatory motions on the lighting fixture and electrical box. A homeowner may be completely unaware of a dangerously supported fixture until a tremor causes it to fall. The danger of inadequately supported lighting fixtures therefore encompasses more fixtures than ceiling fans.

Now there are several electrical box types which will support a relatively heavy load, of which several are represented in U.S. patents. A usual type, represented by U.S. Pat. No. 6,242,696 utilizes flanges attached to the side of the electrical box for attach to a structural member. This type requires installation prior to the installation of a finished ceiling to avoid damage thereto. Another type, represented by U.S. Pat. Nos. RE 38,120, 6,107,568, 6,191,362, 6,207,897 and 6,355,883 envisions a ceiling electrical box that attaches to an overhead structural support member from underneath through the use of screws or other fasteners generally driven upward through the top of the box and into the structural member. Those boxes either include a slot fitting the support member, or are designed to fit in a space between the support member and the surface of the finished ceiling. All of those designs have the disadvantage of reduced internal box volume, by which the number of electrical connections and wires is restricted over a common side-mounted electrical box. Another type, represented by U.S. Pat. Nos. RE 33,147, 6,098,945, 6,465,736, and 6,595,479 utilizes an extendable rod or other structure fittable between the space of two joists or structural members.

This type of electrical box, although avoiding impacts into the volume of the electrical box, carries a number of disadvantages. First, the use of the rod introduces a substantial lever arm; the rod must therefore be fairly heavy to avoid bowing under the fixture load. This type of box is typically constructed of steel or other metal, as the plastic supports would be very thick in comparison. These boxes are more complex and require more materials and building steps to fabricate. The cost of this type of box tends to be much higher to the end user. A final type, represented in U.S. Pat. Nos. RE 34,603 and 6,100,469, utilizes fasteners through a metal electrical box sidewall into the adjacent structural member. This type relies on the strength of the sidewall to avoid the fastener head pulling through the sidewall material under load, and is therefore unsuitable for plastic materials. Furthermore, this type relies on the box structure to resist a downward force, which may place strain on welds and joints. Additionally, fasteners driven in a substantially horizontal direction limit the amount of driving force that can be applied to the fastener and may make installation difficult without specialized tools. And none of these box types provide a method of upgrading a ceiling electrical box to carry additional load after initial installation.

Thus, some of these boxes are relatively expensive to produce and install, while others may be installed only by creating new holes in a ceiling or otherwise causing new damage that must be repaired. The current products and methods do not provide for upgrading of boxes for a heavier fixture. There is therefore a need for products which can create a box or structural device capable of supporting more than a light load which can be installed without causing damage to an existing ceiling.

### BRIEF SUMMARY OF THE INVENTIONS

The disclosed inventions relate generally to electrical boxes that may be installed to a ceiling, and more particularly to electrical box ancillary devices, such as brackets, struts and plates, that permit the carrying of heavy ceiling appliances such as ceiling fans and lighting fixtures. Disclosed herein are mounting bases that are used to attach a ceiling fan to structural members, such as trusses and joists, against the load of fixtures including ceiling fans and lighting fixtures. Additionally these mounting bases sitting between an electrical box and a ceiling fan and need not be attached to an electrical box for any support when installed. In a sense, an electrical box only acts as a wire holding device as a fan is not necessarily supported by any portion of the electrical box. The strength in the attachment of the ceiling fan is carried through to the ceiling fan mounting base with fasteners and then to the structural member through the base itself. Also disclosed herein are methods to orient the mounting base to many types of electrical boxes that are commonly installed today.

A hole pattern in the mounting base may allow for the temporary attachment of a mounting base to an electrical box, which allows for the subsequent orientation to align it with the longitudinal center of the adjacent structural member in relation to the electrical box. After the location of the fan mounting bases to the structural member is found the alignment screws are removed and the ceiling fan mounting base is permanently installed to the adjacent structural member. A trim piece may be placed over the mounting base to hide the mounting base from view. Once alignment screws are removed, the attachment to the electrical box is severed allowing for the ceiling fan to be held independently of the electrical box to the structural member through the mounting base. Additionally disclosed herein, explicitly or implicitly are methods of using and installing those bases, devices and boxes. Detailed information on various example embodiments of the inventions is provided in the Detailed Description below.

### BRIEF DESCRIPTION OF THE DRAWINGS

FIG. 1 shows a metal electrical box attached to a truss with a mounting base below the electrical box.

FIG. 2 shows the installation sequence of several electrical boxes.

FIGS. 3a, 3b and 3c show a mounting base in different orientations and one mounting hole pattern.

FIGS. 4a, 4b, 4c and 4d show a metallic electrical box with a mounting base installed.

FIGS. 5a, 5b, 5c and 5d show a plastic electrical box with a mounting base installed.

FIGS. 6a, 6b, 6c and 6d show a plastic electrical box with a mounting base installed.

FIG. 7 shows an alternate installation with an ordinary ceiling joist of dimensional lumber with the electrical box attached to the structural member and a mounting base.

FIGS. 8a, 8b, 8c and 8d show a trim piece for use with a mounting base after installation.

A discussion of several embodiments in accordance with the invention now follows.

### DETAILED DESCRIPTION

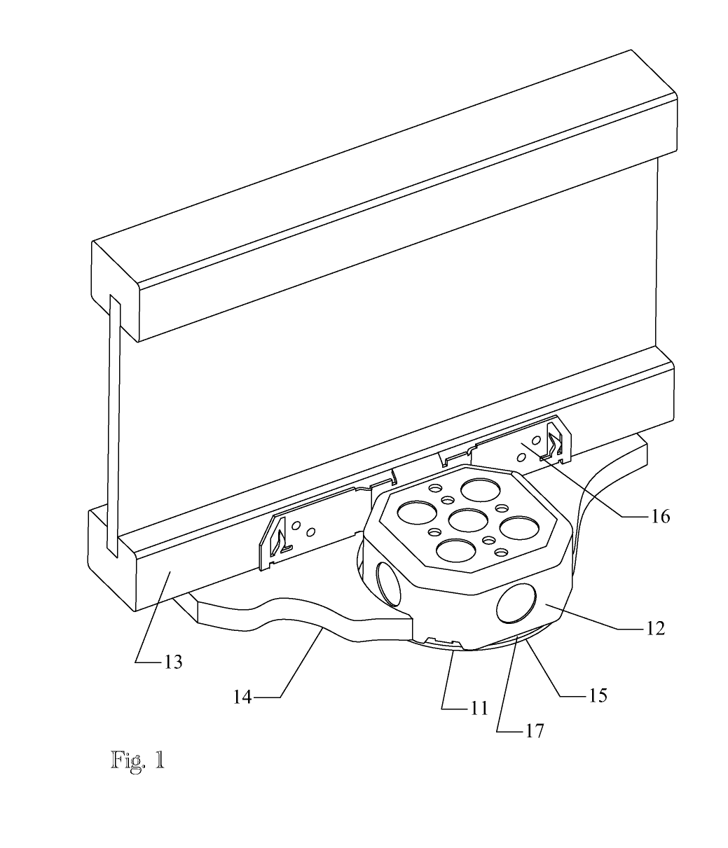

Disclosed herein are mounting bases useful for installing ceiling fans or heavy lighting fixtures to an ordinary electrical box adjacent to a structural member, such as to a truss or joist. FIG. 1 is an example of a metallic electrical box 12 installed against a truss type structural member 13 and the ceiling fan mounting base 11 in the installed position. Mounting base 11 sits between the electrical box 12 and a ceiling fan or fixture, with mounting base 11 being secured to the structural member with several large diameter screws that are driven vertically into the lower plate of the truss or joist along or near its central longitudinal axis. Mounting base 11 includes two largely planar portions, top portion 17 which sits below the lip of the metallic electrical box 12 and ceiling surface 14, in this case drywall though ceilings can also be covered in paneling, lath and plaster or other ceiling treatments. Planar portion 17 forms a parallel surface to the bottom of an electrical box and ceiling surface 14.

Truss 13 is shown as a typical installation in many newer housing and office structures that have been built within the last ten years. Electrical box 12 has been installed against the lower plate of truss 13 through flange 16 with fasteners driven through the mounting holes and is typically installed with nails or screws. The common ceiling surface of gypsum board, drywall or other ceiling surface 14 is installed to form an enclosed ceiling. After ceiling surface 14 is installed access to the metallic box is usually restricted to only the removal of any lighting plates, trim pieces or fixtures that have been installed to cover the open portion of the electrical box. Removal of electrical box 12 without damage to ceiling surface 14 is normally not possible. Mounting base 11 may have a rounded outer lip 15 to accommodate a trim piece and be hidden after installation.

Since the method of attachment for electrical box 12 or other type electrical boxes does not allow easy access to any of the structural members after ceiling surface 14 has been installed other methods must be used to gain access to a structural member for the safe installation of ceiling fans or heavy lighting fixtures.

Mounting base 11 of FIG. 1 may be fashioned utilizing ordinary sheet-metal die-processing and stamping procedures to make the various holes and shapes on the base. Preferred materials for reinforcing brackets, bases and struts, such as mounting base 11, include zinc-plated mild steel, due to that material's strength, durability, widespread availability and manufacturing facilities. Other metals may be used, such as aluminum, brass or “pot” metals, keeping in mind that different thickness may be required to achieve the strength and bracing characteristics. Preferred materials for spacer 28 and threaded bushing fastener 33a can be made from zinc plated, hot or cold rolled steel and can be either, swaged, press fit or spot welded in position after location holes have been created on mounting base 11 for these components.

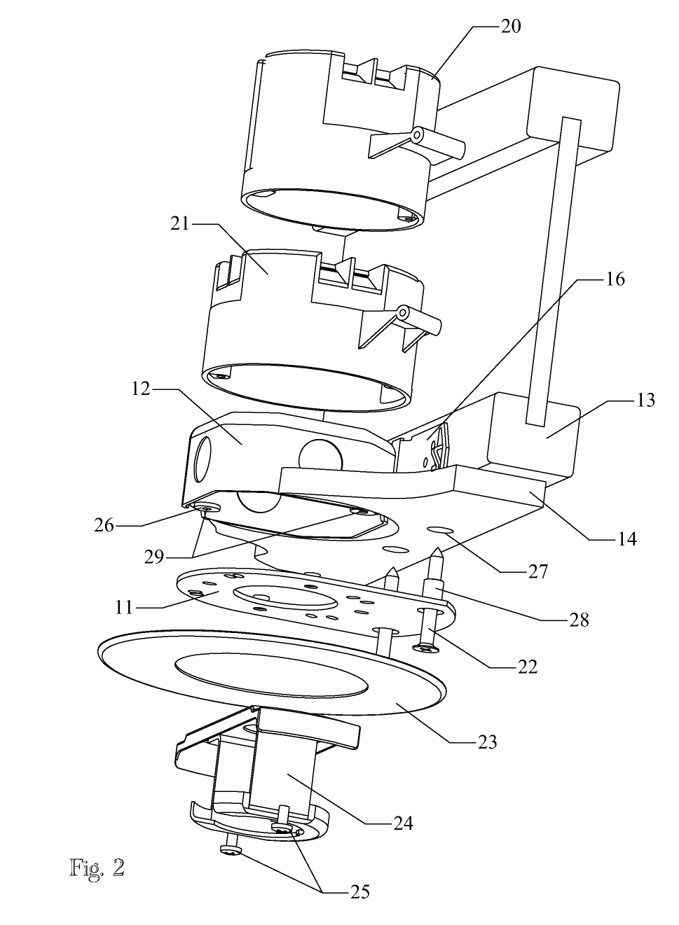

Shown in FIG. 2 is a three and one half inch plastic electrical box 20, a four inch plastic electrical box 21, and a 3.5 inch metallic electrical box 12 with mounting base 11 in position to be installed between the one of the electrical boxes. FIG. 2 is an exploded isometric view of all of the components that a typical ceiling fan installation would require, using the most popular electrical boxes 12, 21 or 20 in use today. The different types of electrical boxes are shown for illustrative purposes which are the major types that are commonly installed in homes and most commercial buildings; electrical box 12 is shown in the installed position. Electrical boxes 20, 21 and 12 include an aperture through which access is permitted to manipulate wires inserted into the electrical box and to make connections thereto.

Electrical boxes 20, 21 and 12 includes flanges, metal flange 16 is for holding electrical box 12 in a relative position whereby nails or screws may be driven into truss 13 to secure electrical box 12 into position. This is done prior to the ceiling surface 14 being installed. The size and type of these flanges vary between the different types of electrical boxes though they all serve the same basic purpose. Screw boss 29 is used to secure an ordinary light fixture, which can also be used to temporarily hold mounting base 11 in position to mark the location for fasteners 22. This marking may be made by inserting a punch or similar tool through spacers 28 on the ceiling surface or truss. In the example, the spacer includes a passage through which a fastener may be attached. That is not necessary; a spacer must merely serve the function of providing an abutment to a structural member through a ceiling covering such as drywall. However, it is convenient that a spacer include a fastener attachment feature whereby a base may be attached to a structural member, for example through a structural fastener into the structural member such as a pilotless screw or bolt. When mounting base 11 is in an installed position, the top planar surface 17 rests against or is in close proximity to the electrical box bottom lip surface 26, and parallel to ceiling surface 14. Fasteners 22 are driven through ceiling surface 14 into truss 13 at approximately its central longitudinal axis to secure mounting base 11 into its installed position.

Holes 27 may be created into the ceiling surface 14 to provide clearance and pilot holes for the fastener spacer 28. These holes may be created by using a drill bit that is sized appropriately and using a drill collar that is adjustable to limit depth and removal of the ceiling surface. This can also be accomplished by using a custom drill bit that includes a small drill on the end to create a pilot hole for fastener 22 along with a depth collar which removes ceiling surface 14 at the same time. Spacer 28 also prevents mounting base 11 from crushing the ceiling surface and allows a rigid connection to the structural member that will not loosen over time due to breakdown of the ceiling surface. Drywall in particular being a gypsum material that is sandwiched between two kraft paper outer layers is subject to material breakdown over time if it is held in a compressed state and subject to oscillatory forces. By placing spacer 28 against the structural member, the loosening of fasteners 22 is unlikely to occur over time. Spacer 28 is also sized to the prevalent height of one half inch which is the thickness of most ceiling surfaces in use today. Spacer 28 can also be used with washers when additional thickness is needed. Trim piece 23 is shown in the ready to install position between the ceiling fan installation bracket 24 and mounting base 11. Trim piece 23 may be held in place by friction or other means between installation bracket 24 which is a ceiling fan mounting bracket with screws 25. Trim piece 23 could also be held in position by a lighting fixture supplied by the components manufacturer and installs to mounting base 11 with screws 25 as well. If friction fit is used trim piece 23 could be moved around and cover mounting base 11 to best advantage, since some installations will need minor adjustment to allow alignment to a fan or lighting trim components.

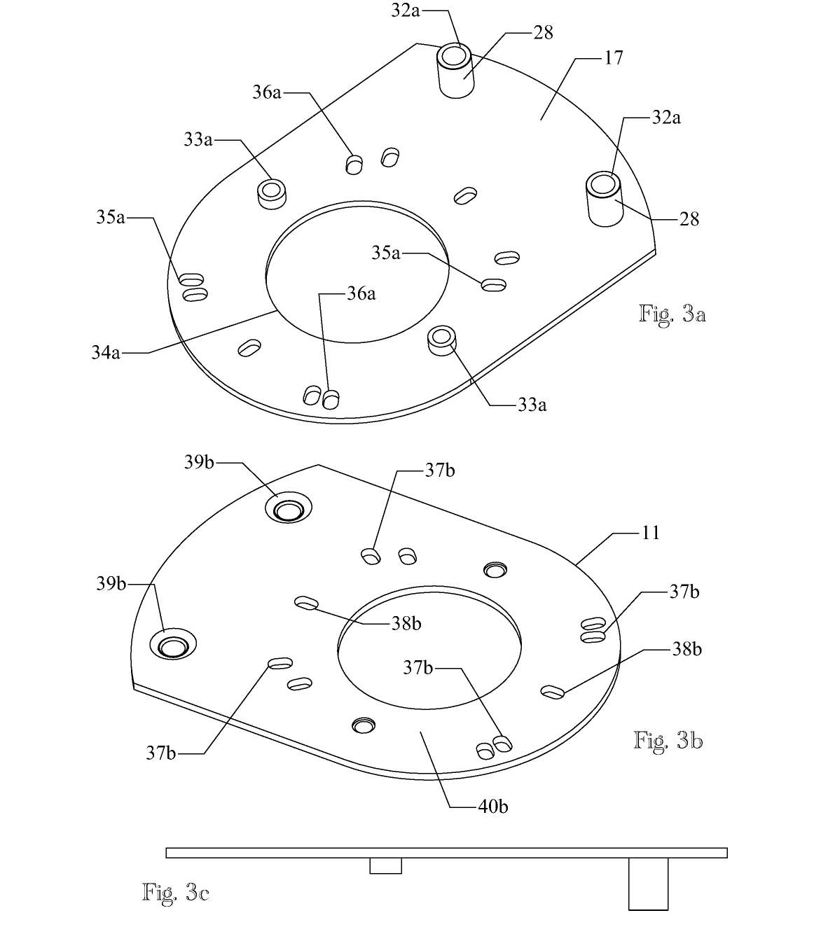

FIG. 3a shows mounting base 11 in an isometric view of planar surface 17 that rests on ceiling surface which may make contact with an electrical box when in the installed position or planar to and/or against ceiling surface. Spacers 28 are shown in there installed position and allow fasteners to pass through into the structural member, such as truss 13 of FIG. 1. The bottom of fastener 28 has a ledge feature 32a that rests on a structural member after pilot holes have been created. This keeps mounting base 11 from crushing the ceiling material if mounting base 11 is installed in conjunction with a ceiling surface.

Spacers 28 may be advantageously made from zinc plated steel or other appropriate non-rusting materials and may be press fit, welded or staked into position to provide a secure fit to mounting base 11. In this example fasteners 33a are threaded bushing type fasteners and are staked in position by press fit or other means and are positioned on mounting base 11 to provide the correct distance for the attachment of ceiling fans and lighting fixtures. This distance is set by common practice by the lighting and electrical box manufacturers. For example, fasteners 33a may be sized for No. 10 screws, which allow a greater load bearing capability than No. 8 fasteners that are standard on most all electrical boxes. Screws are may be inserted into mounting base 11 by starting the screw from the opposite side from planar surface 17.

Aperture 34a is a through hole that allows the ceiling fan or lighting fixture wires to pass inside the electrical box through mounting base 11 and make connection to the electrical cable or wiring inside an electrical box. Through slots 35a and 36a are included as a hole pattern for mounting base 11; these holes are positioned to allow an electrical box such as 12 from FIG. 1, to be positioned to the mounting base aligning spacers 28 with the center longitudinal axis of a structural member. This is done by placing mounting base 11 against ceiling surface 14 with spacers 28 pointing towards the floor. The mounting base is shown in the correct orientation when temporarily installed in FIG. 3c, inserting two fasteners through top surface of mounting base 11 using planar surface 17 into slots 35a and into the screw threads of threaded bosses 29 of FIG. 2 to temporarily fasten in place.

Two sets of slots for electrical box 12 are provided since some manufacturers use a left to right configuration for threaded bosses 29 of FIG. 2 and some use a right to left configuration shown as slots 36a, though they usually only two attachment points for lighting fixtures regardless of the configuration. Slots 35a and 36a allow mounting base 11 to be positioned and centered by eye within the aperture provided by electrical boxes 12, 20 & 21 of FIG. 2 which house the wiring and cables for these electrical boxes. Spacers 28 may then be used to slide a punch or similar marking tool to locate the position where holes 27 of FIG. 2 are located. Clearance holes for spacers 28 may be created if needed as explained above. After marking, mounting base 11 may then be removed. Mounting base 11 may then be reversed and installed by passing screws through countersink 39b of FIG. 3b and tightening the fasteners 22 until they are essentially flush with planar surface 40b.

FIG. 3b is an isometric view that shows mounting base 11 and the mating surface for a ceiling fan or a lighting fixture planar surface 40b. Countersink 39b is sized to allow screws to be flush with planar surface 40b of mounting base 11 when the fasteners are fully tightened avoiding interference with trim piece 23 of FIG. 2 when installed. Slots 37b are used to position plastic electrical box 21 of FIG. 2 with truss 13 of FIG. 2 and its center longitudinal axis. Mounting base 11 is then installed in the same manner as outlined above by inverting it as shown in FIG. 3c and locating and creating fastener holes as needed. Again two sets of slots 37b are provided to allow a mirrored configuration when the mounting base 11 is used to locate the central longitudinal axis of truss 13, by inverting and temporarily installing mounting base 11 when installing to electrical box 21 of FIG. 2. Only one set of slots 38b is needed since mounting base 11 is intended to be inverted with planar surface 17 visible to the installer. When the base is inverted these slots will align with screw bosses that are supplied by the manufacturers and are centered on electrical box 20 of FIG. 2. Slots 38b are used for plastic electrical box 20 of FIG. 2 with truss 13 to find its center longitudinal axis. The base is then installed in the same manner as outlined above by inverting mounting base 11 as shown is FIG. 3c and locating and creating the fastener holes as previously described.

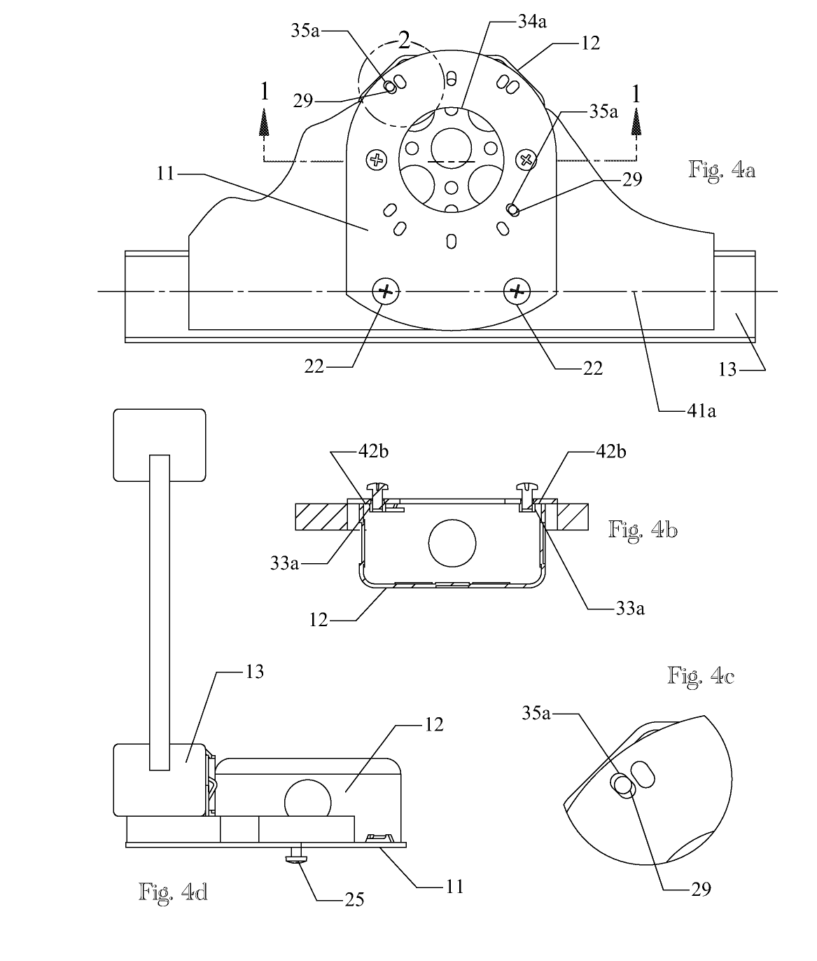

FIG. 4a is a straight on view of mounting base 11 as installed on electrical box 12a. Slots 35a are aligned with a left to right configuration at the top of the view and show how they align with screw bosses 29. This alignment sets the position for fasteners 22 along the longitudinal axis 41a which is approximately centered on the lower plate of truss 13. Aperture 34a allows the passage of wires and cables between electrical box 12 and an installed ceiling fan or lighting fixture. FIG. 4b shows a sectioned view shown by section line 1-1 of bushing fastener 33a with clearance 42b on each side of electrical box 12. A ceiling fan or light fixture may be attached to mounting base 11 and not screw boss 29 using threaded bushings 33a. FIG. 4c is a detail view of the alignment of slot 35a and threaded screw boss 29 of the electrical box 12. Notice how it automatically aligns the mounting base with the longitudinal axis 41a when temporarily attached to electrical box 12, shown by detail 2 in FIG. 4a. FIG. 4d shows installed electrical box 12 in a section view of the upper and lower plate of truss 13 and the edge view of mounting base 11. Screws 25 are shown as they would be installed to mounting base 11, a ceiling fan bracket or light fixture could install with these screw into threaded bushing fasteners 33a of FIG. 4b.

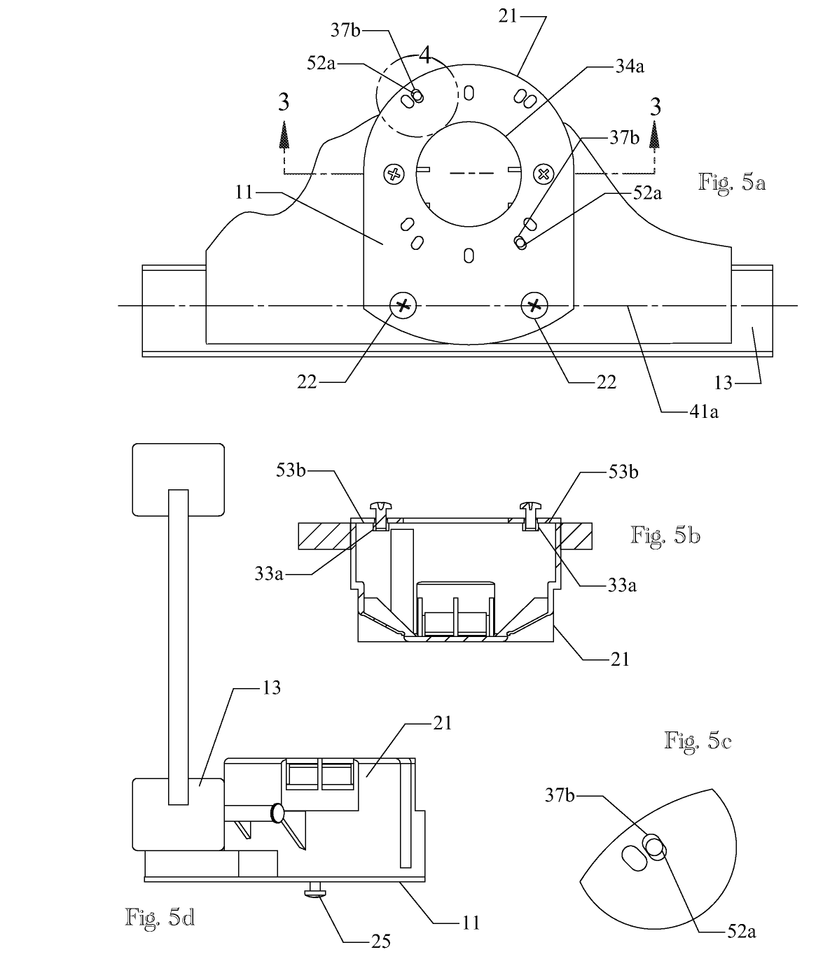

FIG. 5a is a straight on view of mounting base 11 as it would be installed onto a plastic electrical box 21. Slots 37b are aligned with a left to right configuration; from the top of the view it can be seen how these align with screw bosses 52a for the 8-32 fixture installation screws provided typically with an electrical box. This alignment sets the position for fasteners 22 along the longitudinal axis of 41a which is approximately centered on the lower plate of truss 13. Aperture 34a allows the passage of wires and cables between electrical box 21 and an installed ceiling fan or lighting fixture. FIG. 5b shows a section view shown by section line 3-3 of the threaded bushing fasteners 33a with clearance 53b on each side of electrical box 21, as a ceiling fan of light fixture needs to be attached to mounting plate 11 and not threaded screw bosses 52a. FIG. 5c is a detail view of the alignment of slot 37b and threaded screw boss 52a of electrical box 21, shown by detail 4 in FIG. 5a. FIG. 5d shows the installed electrical box 21 as a section view of the lower plate of truss 13 and the edge view of mounting base 11. Screws 25 are shown as they would be installed to mounting base 11, a ceiling fan bracket or light fixture would install with these screws into threaded bushing fasteners 33a of FIG. 5b.

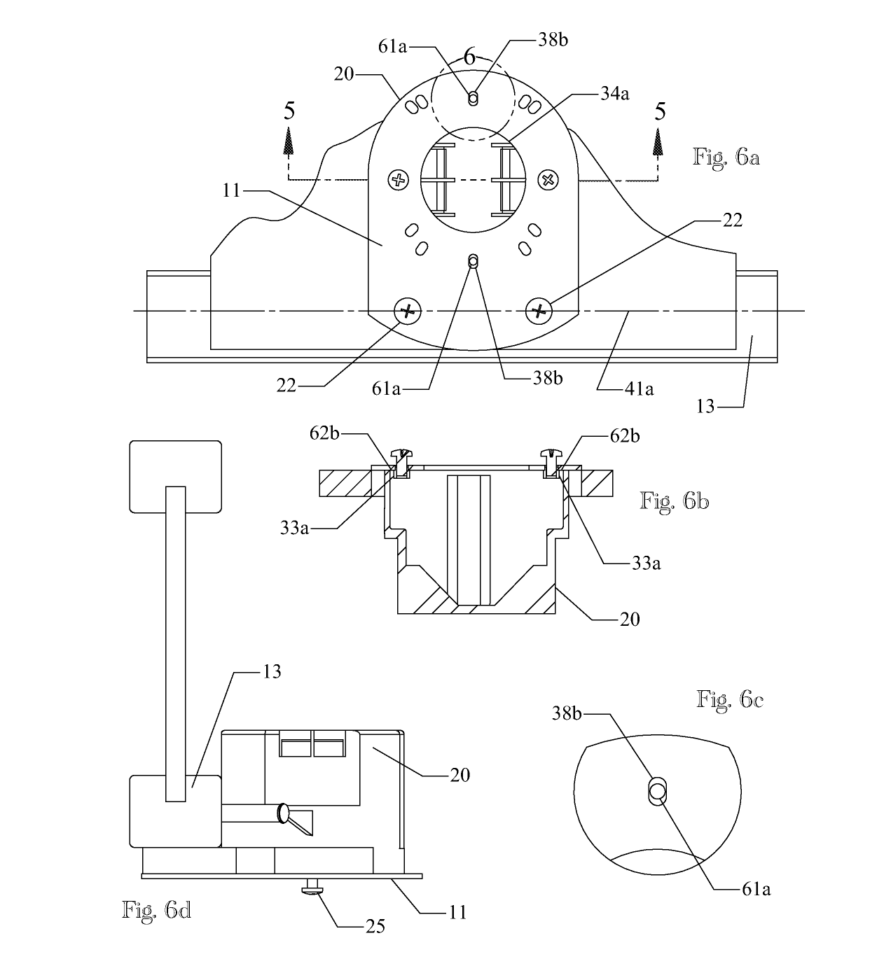

FIG. 6a is a straight on view of mounting base 11 as it would be installed on plastic electrical box 20. Slots 38b are aligned with a top to bottom configuration; from the top of the view it can be seen how these align with screw bosses 61a for the 8-32 fixture installation screws typically with an electrical box. This alignment sets the position for fastener 22 along the longitudinal axis 41a which is approximately centered on the lower plate of truss 13. Aperture 34a allows the passage of wires and cables between the electrical box 20 and an installed ceiling fan or lighting fixture. FIG. 6b shows a section view shown by section line 5-5 of the threaded bushing fastener 33a with clearance 62b on each side of electrical box 20. A ceiling fan of light fixture is attached to mounting base 11 and not 61a using fastener bushing 33a. FIG. 6c is a detail view of the alignment of slot 38b and threaded screw boss 61a of electrical box 20, shown by detail 6 in FIG. 6a. FIG. 6d shows installed electrical box 20 as a section view of the lower plate of truss 13 and an edge view of mounting base 11. Screw 25 is shown as they would be installed to mounting base 11; a ceiling fan bracket or light fixture would install with these screws into the threaded bushing fastener 33a of FIG. 6b.

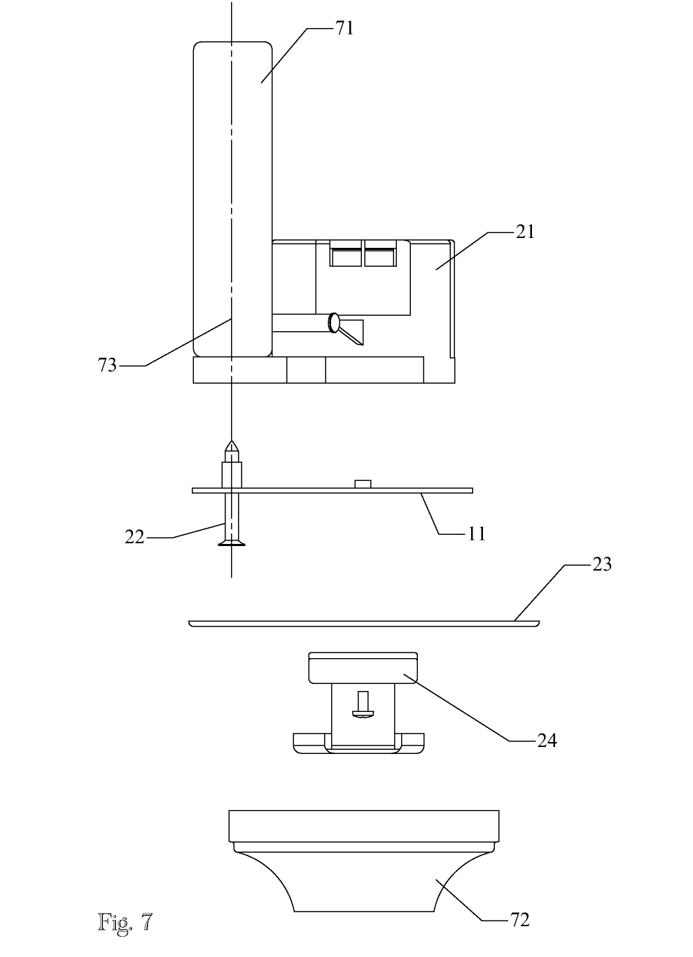

FIG. 7 shows an exploded side view of a typical installation using a mounting base 11 and a trim piece 23. This figure illustrates that the system is capable of being used with an ordinary joist of dimensional lumber 71, generally it does not matter what style of joists or trusses are used the result is the same as with truss 13. Mounting base 11 aligns in the same manner as with truss 13 on the center of vertical axis 73, shown here from the side. The sequence of installation is the same, mounting base 11 is located by using the hole pattern features of the screw boss alignment holes for the particular electrical box that is currently installed. Mounting base 11 is secured with screws 22 after creating pilot and spacer holes if needed. Trim piece 23 may be placed in position and secured in place by placing the ceiling fan bracket 24 or a light fixture and using screws 25 to hold both trim piece 23 and ceiling fan bracket 24 in position. It is intended that before final tightening of screw 25 that the trim piece would be shifted to center it on mounting base 11 and covering the mounting base to full advantage. Finally the bracket cover 72 is secured in position over the ceiling fan bracket 24 to finish the installation if supplied by the light fixture or ceiling fan manufacturer.

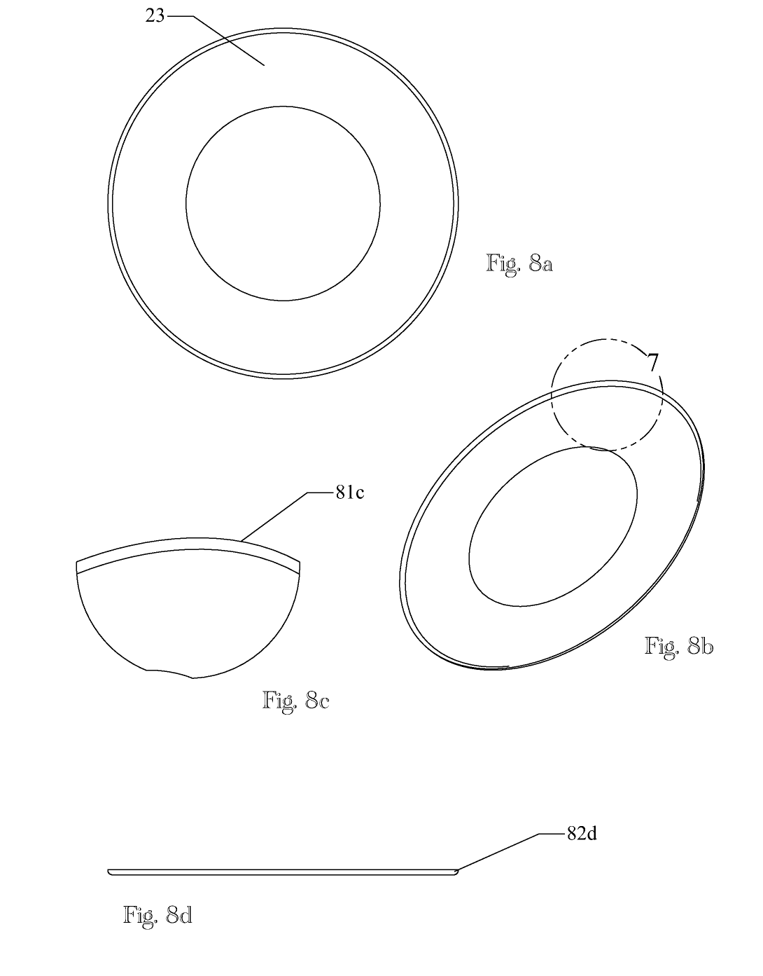

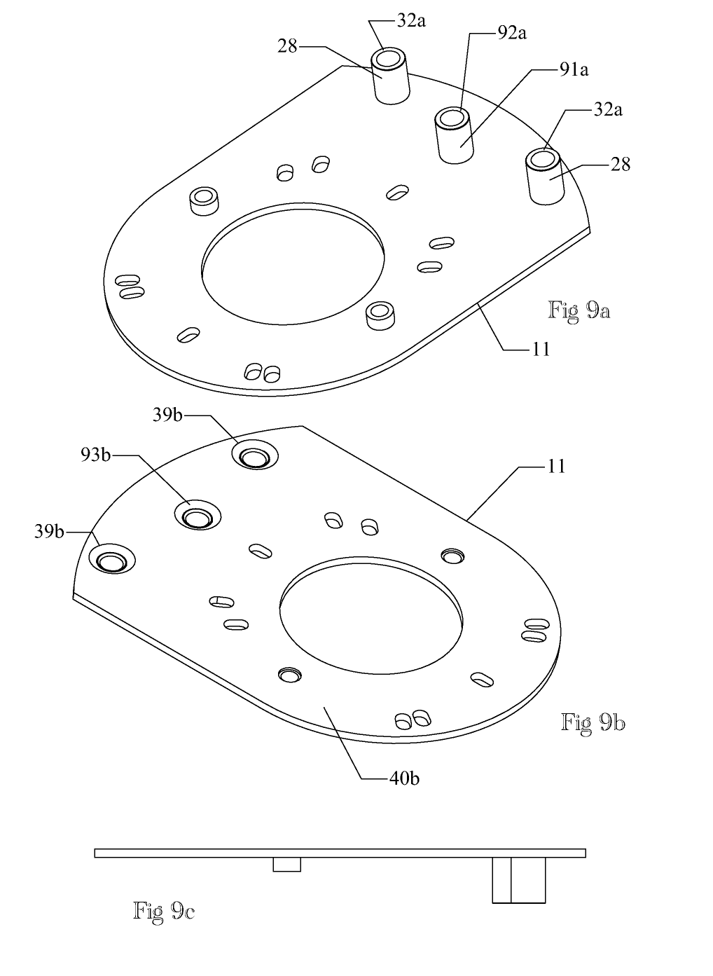

FIG. 8a shows trim piece 23 with a raised edge around the outer circumference and has a larger diameter than mounting base 11. This allows trim piece 23 to be shifted to completely cover mounting base 11 and center it with the ceiling fan or lighting fixture. FIG. 8b is a detail view of the raised edge feature with edge 81c of FIG. 8c, which edge is approximately equal in height to the thickness of mounting base 11 as shown detail 7 in FIG. 8b. FIG. 8d shows trim piece 23 in the installed orientation with a thin appearance 82d on its edge.

FIG. 9a shows an alternate configuration a for mounting base 11 with an additional spacer 91a in a center location between and in addition to spacers 28. This configuration will also place fasteners 22 of FIG. 2 on each side of the approximate center longitudinal axis of truss 13 of FIG. 1 and shown as line 41a in FIGS. 4a, 5a and 6a. The addition of spacer 91a allows for conditions where additional support is either needed or required as would be the case for the placement of a chandelier or other heavy lighting fixture and gives the installer more options when installing mounting base 11. It also has the added benefit of being able to install a fastener if a defect such as knot in the support member was at the same location as the fasteners location giving the installer the option of using an alternate fastener location 39b in conjunction with spacer 91a. Spacer 91a also has the same features of spacers 28 with the same ledge 92a which is 32a for spacer 28 and serves the same purpose as described previously.

FIG. 9b is an isometric view that shows mounting base 11 and the mating surface for a ceiling fan or a lighting fixture, planar surface 40b. Countersink 93b and 39b are sized to allow fasteners to be flush with planar surface 40b of mounting base 11 when the fasteners are fully tightened and will not interfere with trim piece 23 of FIG. 2 when installed. Countersink 93b and 39b are sized for one quarter inch fasteners for added strength and support. FIG. 3c is an edge view of mounting base 11 in the temporary installed position that is used for marking the location of the structural member. The addition of the third countersink and spacer are not all inclusive for example all that is needed is ones spacer and could be placed on mounting base 11 in various locations that the center longitudinal axis of the lower plate of truss 13 of FIG. 1. They may also be grouped together with two on each side with one or more in the center. Mounting base 11 may also be manufactured with embossed features or ridges that give the base additional rigidity and its size could also be increased for custom or specific applications where warranted.

Now it is preferred that reinforcement brackets, devices, bases or features be designed to consume a minimal amount of the interior volume for attachment to an electrical box, so as to maximize the number of wires and electrical connections that can be made within the electrical box. The only intrusion of exemplary mounting base 11 is by threaded bushing fasteners 33a.

A kit containing a mounting base and fasteners may be advantageously assembled for the convenience of the installer. Such a kit might be included, for example, in the product packaging of an electrical appliance, for example a ceiling fan or lighting fixture, providing added convenience to the installer of the product in situations where the use of the ceiling fan mounting base is desirable. A fastener and drill bit with a suitable collar for depth suitable for insertion into a drill may also add to the convenience of the installer at a reasonable expense.

A preferred fastener type for use with reinforcement devices, bases and brackets is the pilot less screw, as commonly used in decking, fencing and drywall applications. That type of screw can be driven into woods used for construction as well as many plastics with minimal splitting and/or stretching of the material. The use of that type of screw simplifies the installation of the mounting base by reducing the need for drilling pilot holes though they are the preferred method of installation, which under many circumstances will be awkward given the overhead working position. The use of screws is also preferred to mitigate the effects of thermal humidity cycles, which is a known problem with nails. Screws are not the only type of fasteners that could be used so as not to exclude the possibility of bolts or other types of anchors and fasteners.

While reinforcing brackets, devices, bases, and electrical boxes containing reinforcement and the use of those have been described and illustrated in conjunction with a number of specific configurations and methods, those skilled in the art will appreciate that variations and modifications may be made without departing from the principles herein illustrated and described. The present invention as defined by the drawings and descriptions may be embodied in other specific forms without departing from its spirit or essential characteristics. The configurations described herein are to be considered in all respects as only illustrative, and not restrictive. All changes which come within the meaning and range of equivalence of the disclosures are to be embraced within their scope.

What is claimed is:

1. A device for hanging a ceiling fixture from a ceiling having a structural member and an electrical box, the structural member and electrical box being covered by a ceiling covering such as drywall, said device comprising:
a base being installable to the ceiling in an installation position, wherein said base has a top surface configured to be positioned adjacent to the ceiling covering in the installation position;
a spacer adjoining said base having a length of that of distance between the structural member and the exterior ceiling covering surface;
a fastener attachment to said base and a structural fastener, both configured to allow the fixing of said base to the structural member by said structural fastener, wherein the position of said fastener attachment locates said structural fastener at about the centerline of the structural member when said device is in the installation position;
fixture fasteners affixed to said base, said fixture fasteners each configured to accept the attachment of a ceiling fixture;
a wiring access aperture within said base in a position whereby the interior of the electrical box is accessible through said aperture when said base is in the installation position;
whereby the weight of a ceiling fixture attached by said fixture fasteners is carried through said structural fastener.

2. A device according to claim 1, wherein said electrical box further includes a pair of attachment points for attaching a ceiling fixture, wherein said base further comprises a pair of slots positioned to mate with the attachment points of the electrical box.

3. A device according to claim 2, wherein said slots are located in a position such that the position of said fastener attachments or said spacers can be marked when said base is in a reverse position.

4. A device according to claim 2, wherein said base further comprises an additional pair of slots positioned to mate with the attachment points of a different electrical box.

5. A device according to claim 1, wherein said device further comprises a trim piece, and further wherein said base is optionally adapted to mate to said trim piece.

6. A device according to claim 5, wherein said trim piece is configured to be secured against the ceiling covering and wherein said trim piece covers said base.

7. A device according to claim 1, wherein the top surface of said base provides a mating against a substantially flat surface.

8. A kit containing a device according to claim 1 further comprising a set of spacers for different thicknesses of ceiling coverings.

9. A device according to claim 1, wherein said fastener attachment is countersunk.

10. A device according to claim 1, wherein said fixture fasteners are configured to protrude into the internal space of the electrical box in the installed position.

11. A device according to claim 1, wherein said fastener attachment includes a passage through said spacer.

12. A device for hanging a ceiling fixture from a ceiling having a structural member and an electrical box, the structural member and electrical box being covered by a ceiling covering such as drywall, said device comprising:
a base being installable to the ceiling in an installation position, wherein said base has a top surface configured to be positioned adjacent to the ceiling covering in the installation position;
a spacer adjoining said base having a length of that of distance between the structural member and the exterior ceiling covering surface;
a plurality of fastener attachments to said base and a same number of structural fasteners, both configured to allow the fixing of said base to the structural member by said structural fasteners;
fixture fasteners affixed to said base, said fixture fasteners each configured to accept the attachment of a ceiling fixture;
a wiring access aperture within said base in a position whereby the interior of the electrical box is accessible through said aperture when said base is in the installation position;
whereby the weight of a ceiling fixture attached by said fixture fasteners is carried through said structural fastener.

13. A device according to claim 12, wherein said electrical box further includes a pair of attachment points for attaching a ceiling fixture, wherein said base further comprises a pair of slots positioned to mate with the attachment points of the electrical box.

14. A device according to claim 12, wherein said slots are located in a position such that the position of said fastener attachments or said spacers can be marked when said base is in a reverse position.

15. A device according to claim 12, wherein said base further comprises an additional pair of slots positioned to mate with the attachment points of a different electrical box.

16. A device according to claim 12, wherein said device further comprises a trim piece, and further wherein said base is optionally adapted to mate to said trim piece.

17. A device according to claim 16, wherein said trim piece is configured to be secured against the ceiling covering and wherein said trim piece covers said base.

18. A device according to claim 12, wherein the top surface of said base provides a mating against a substantially flat surface.

19. A kit containing a device according to claim 12 further comprising a set of spacers for different thicknesses of ceiling coverings.

20. A device according to claim 12, wherein said fastener attachment is countersunk.

21. A device according to claim 12, wherein said fixture fasteners are configured to protrude into the internal space of the electrical box in the installed position.

22. A device according to claim 12, wherein said fastener attachment includes a passage through said spacer.

23. A method of installing a ceiling fixture to a ceiling structure behind a ceiling covering, wherein an electrical box has been previously affixed in adjacency to the structural member, said method comprising the steps of:
providing a device comprising a base, a spacer, a fastener attachment, a structural fastener, fixture fasteners, and a wiring access aperture, wherein the base is installable to a ceiling in an installation position, wherein the base has a top surface configured to be positioned adjacent to a ceiling covering in the installation position, wherein the spacer adjoins the base and has a length of that of distance between the structural member and the exterior ceiling covering surface, wherein the fastener attachment and structural fastener are both configured to allow the fixing of the base to the structural member by the structural fastener, wherein the position of the fastener attachment locates the structural fastener at about the centerline of the structural member when the device is in the installation position, wherein fixture fasteners are affixed to the base and are each configured to accept the attachment of a ceiling fixture, wherein the wiring access aperture is located within the base in a position whereby the interior of the electrical box is accessible through the aperture when the base is in the installation position;
placing the device in reverse orientation to the electrical box, locating one of the slot pairs to the electrical box;
optionally fastening the device to the electrical box;
optionally marking the spacer locations on the ceiling covering, wherein said marking is optionally performed by a marking tool;
removing material from the ceiling covering at the spacer locations;
reversing the device in an attachment orientation to the electrical box;
fastening the device to the structural member; and
attaching a fixture to the device.
